(19) United States
(12) Patent Application Publication
(10) Pub. No.: US 2013/0198654 A1
(43) Pub. Date: Aug. 1, 2013

(54) Systems, Methods, and Computer Programs for Controlling a Conference Interface Without Joining as a Participant

(71) Applicant: AMERICAN TELECONFERENCING SERVICES, LTD., Atlanta, GA (US)

(72) Inventors: Boland T. Jones, Atlanta, GA (US); David Michael Guthrie, Norcross, GA (US); Mark A. Sjurseth, Smyrna, GA (US); John P. Keane, Marietta, GA (US); Daniel Owens, Atlanta, GA (US)

(73) Assignee: AMERICAN TELECONFERENCING SERVICES, LTD., Atlanta, GA (US)

(21) Appl. No.: 13/802,434

(22) Filed: Mar. 13, 2013

Related U.S. Application Data
(63) Continuation-in-part of application No. 12/771,979, filed on Apr. 30, 2010.
Application No. 12/771,979 is a continuation-in-part of application No. 12/772,069, filed on Apr. 30, 2010.
Application No. 12/772,069 is a continuation-in-part of application No. 13/078,277, filed on Apr. 1, 2011.
Application No. 13/078,277 is a continuation-in-part of application No. 13/078,132, filed on Apr. 1, 2011.

(51) Int. Cl. H04L 29/06

(52) U.S. Cl. CPC H04L 65/403
USPC 715/753

(57) ABSTRACT

A method for monitoring and controlling a conference interface includes receiving a request indicating that a notification of an event associated with the conference interface is desired, determining occurrence of the event, sending the notice to a computing device that initiated the request, receiving an out-of-conference communication from the computing device and in response thereto, modifying a characteristic of the conference interface. A system includes computing devices coupled to a conferencing platform via one or more networks. The conference platform operates a web server that publishes a graphical user interface associated with an identified subscriber. A computing device associated with the identified subscriber is provided an application that enables the computing device to communicate a request for notification of an event in their conference interface without being present in the conference interface. The application enables the computing device to receive notification of the event and to respond to the same.

### CROSS-REFERENCE TO RELATED APPLICATIONS

This application is a continuation-in-part patent application of and claims the benefit of the priority of the following copending patent applications, each of which is hereby incorporated by reference in its entirety: U.S. patent application Ser. No. 12/771,979 entitled “Conferencing Alerts” and filed on Apr. 30, 2010 (Attorney Docket No. 1202U1); U.S. patent application Ser. No. 12/772,069 entitled “Managing Conference Sessions via a Conference User Interface” and filed on Apr. 30, 2010 (Attorney Docket No. 16003.1210U1); U.S. patent application Ser. No. 13/078,277, entitled “Managing Multiple Conferences via a Conference User Interface” and filed on Apr. 1, 2011 (Attorney Docket No. 16003.1232U1); and U.S. patent application Ser. No. 13/078,132, entitled “Systems, Methods, and Computer Programs for Monitoring a Conference and Communicating with Participants without Joining as a Participant” and filed on Apr. 1, 2011 (Attorney Docket No. 16003.1233U1).

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other media to communicate with one another. These conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of conferencing systems, computer programs and methods for monitoring and interacting with a conferencing platform are disclosed. One embodiment is a conferencing system that enables a subscriber to a service to monitor and respond to activity in an interface published by the conferencing system. The conferencing system includes a conference platform that operates a web server that publishes a graphical user interface associated with an identified subscriber. The conferencing system is communicatively coupled to computing devices via one or more networks. One of the computing devices is associated with the identified subscriber. The computing device includes an application that when executed enables the communication of a request to the conferencing platform from the computing device, the request including an indication that a notification of an event associated with the graphical user interface is desired. The application further enables the receipt of a notification from the conferencing system when the event is detected by the conferencing platform and for communicating with the conference platform in a manner that directs the conferencing platform to modify a characteristic of the graphical user interface.

An example embodiment is a computer program embodied in a computer readable medium and executed by a processor for monitoring an interface and communicating with a conferencing system managing the interface. The computer program includes logic for communicating a request to the conferencing system from a computing device, the request including an indication that a notification of an event associated with an identified interface generated by the conferencing system is desired, the identified interface comprising a graphical user interface published by the conferencing system and associated with an operator of the computing device. The program further includes logic for receiving a notification from the conferencing system at the computing device, the notification indicating the occurrence of the predetermined event and logic for communicating with the conferencing system from the computing device outside of the graphical user interface published by the conferencing system, a communication from the computing device that directs the conferencing system to modify a characteristic of the graphical user interface published by the conferencing system.

Another embodiment is a method for monitoring and controlling a conference interface without joining as a participant to the conference. The method includes receiving at a conferencing system, a request communicated from a computing device, the request including an indication that a notification of an event associated with an identified interface generated by the conferencing system is desired, the conferencing system, determining the occurrence of the event, the conferencing system, sending a notification to the computing device, the notification indicating the occurrence of the predetermined event, receiving at the conferencing system, an out-of-conference communication from the computing device and the conferencing system, in response to the out-of-conference communication, modifying a characteristic of the identified interface.

### BRIEF DESCRIPTION OF THE DRAWINGS

FIG. 1 is a block diagram illustrating an embodiment of a conferencing system.

FIG. 2 is a block diagram illustrating an embodiment of an identified virtual conference published by the conferencing system of FIG. 1.

FIG. 3 is a schematic diagram illustrating an embodiment of the non-participant computing device of FIG. 1.

FIG. 4 is a schematic diagram illustrating an embodiment of a machine interface for communicating a request to the conferencing system of FIG. 1.

FIG. 5 is a schematic diagram illustrating an embodiment of a machine interface for receiving a notice from the conferencing system of FIG. 1.

FIG. 6 is a schematic diagram illustrating an embodiment of a machine interface for communicating an out-of-conference message to participants present in the identified virtual conference of FIG. 2.

FIG. 7 is a flow diagram illustrating an embodiment of a method for monitoring a conference interface and communicating with participants without joining as a participant.

### DETAILED DESCRIPTION

Various embodiments of systems, methods, and computer programs are disclosed for enabling a user of a computing device (referred to as a “non-participant”) to monitor events in a conference, communicate with conference participants, and/or control aspects of the conference without necessarily joining the conference as a participant. The conference may comprise any online conference, meeting, grouping, or other types of gatherings (collectively, a “conference”, with a system that provides the conference being referred to as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference and conferencing system and related features may be implemented as described in the parent patent application, U.S. patent application Ser. No. 12/771,979, which is hereby incorporated by reference in its entirety. The communication between the non-participant's computing device and the conferencing system may be implemented in a manner similar to the parent patent application, U.S. patent application Ser. No. 13/078,132, which is hereby incorporated by reference in its entirety.

As described below in more detail, the various embodiments enable the non-participant to monitor and/or interact with the conferencing system or platform, via a computing device, without necessarily joining the conference as a participant. The non-participant may monitor conference events, exchange out-of-conference messages with participants, and/or control aspects of the conference (e.g., close or terminate an existing meeting, reschedule a meeting, etc.) without necessarily joining the conference as a participant.

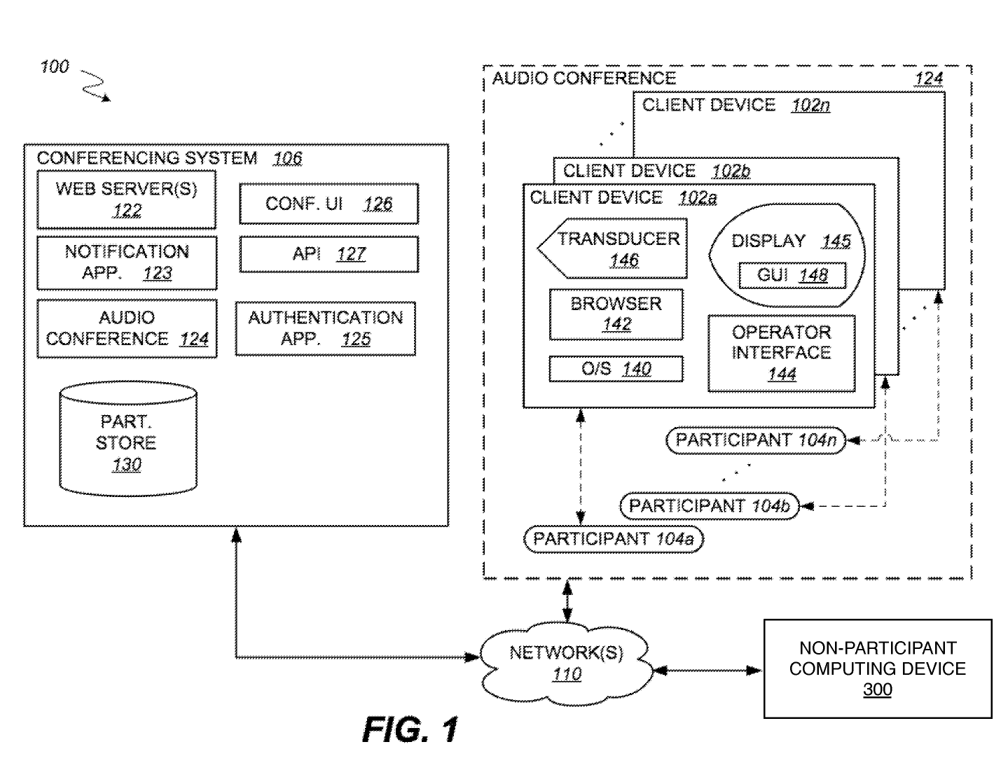

FIG. 1 illustrates a conferencing environment 100 representing an exemplary working environment for enabling participants 104 to join an audio conference 124. The participants 104 are registered subscribers of a conference service provided by the conferencing system 106. The audio conference 124 comprises computing devices 102 in communication with a conferencing system 106 and web server(s) 122 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure. The conferencing system 106 establishes a conference (e.g., an audio conference 124) between computing devices 102 associated with participants 104a-104n. The audio conference 124 may have a corresponding online component presented to the participants 104 via a conference user interface 126. In an embodiment, the conference user interface 126 may be configured in any of the ways described in the above-referenced parent patent applications, or others, to provide a visually engaging conference experience via the browser 142 to participants 104. When the computing device 102 is arranged with an integrated transducer 146 or coupled to an external transducer or transducers, the conference user interface 126 can produce sound at designated times such as when a participant 104n joins the audio conference 124.

The computing devices 102 may comprise any desirable computing device, which is configured to communicate with the conferencing system 106 and the web server(s) 122 via the networks 110. The computing device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device 102 capable of communicating with the conferencing system 106 and/or the web server(s) 122 via one or more networks 110. The computing device 102 may include a display device 145, a processor, memory, and software, including an operating system 140, a graphical user interface 148, and client software (e.g., a browser 142, plug-in, or other functionality) configured to facilitate communication with the conferencing system 106 and the web server(s) 122. It should be appreciated that the hardware, software, and any other performance specifications of the computing device 102 are not critical and may be configured according to the particular context in which the computing device 102 is to be used. In this regard, the computing device 102 may include one or more transducers 146 for reproducing one or more an audio signals as well as an operator interface 144 for receiving inputs from an operator of the computing device 102. Further in this regard, the operator interface 144 may include one or more of a touch sensitive screen, a keyboard, a microphone, a thumb wheel or other human-machine interface that functions in conjunction with the GUI 148.

The conferencing system 106 generally comprises a communication system for establishing an audio conference 124 between the computing devices 102. The conferencing system 106 may support audio via a voice network and/or a data network. In one of a number of possible embodiments, the conferencing system 106 may be configured to support, among other platforms, a Voice over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 is configured to establish a data and/or audio connection with the computing devices 102. The conferencing system 106 may establish the audio conference 124 by combining audio streams associated with the participant computing devices 102.

As illustrated in FIG. 1, in contrast to the participants 104a-104n, the non-participant computing device 300 is associated with a non-participant who is not connected to the conference or audio conference 124 as a participant. The non-participant may be a scheduled host or a scheduled participant who has not yet joined the conference or another individual or group of individuals who wishes to monitor the conference and/or communicate with the participants 104 without necessarily joining the conference. The terms “host” and “participant” merely refer to different user roles or permissions associated with the conference. For example, the “host” may be the originator of the conference and, consequently, may have user privileges that are not offered to the participants. Nonetheless, it should be appreciated that the terms “host,” “participant,” and “user” may be used interchangeably depending on the context in which it is being used and that the term “non-participant” merely refers to a user that is not currently connected to the conference via conferencing system 106.

The conferencing system 106 includes web server(s) 122, a notification application 123, an authentication application 125, the conference user interface 126, and an application programming interface (API) 127. The web server(s) 122 are computers, virtual machines, or computer operated programs that publish information from the conference user interface 126 to coupled computing devices 102 using, for example, the Hypertext Transfer Protocol (HTTP), over the networks 110.

The authentication application 125 is a computer operated program that is arranged to confirm the identity of a possible conference participant such as the participant 104n before connecting the computing device 102n associated with the participant 104n to the audio conference 124 and before exposing the conference user interface 126 via a browser 142 and display 145 to the participant 104n. The authentication application can be arranged to employ any number of queries or information exchanges with the participant 104n in an effort to confirm the identity of the possible conference participant as a subscriber to the conferencing service provided by the conferencing system 106.

The authentication application 125 is arranged to communicate with participant store 130 to complete the participant authentication. The participant store 130 contains the names and/or usernames and access codes for subscribers of the conferencing service supported by the conferencing system 106. In some embodiments the participant store 130 contains additional information that can be used to confirm the identity of subscribers to the conferencing service. This additional information can include images, questions associated with answers entered by an identified subscriber, among other information not commonly known by those other than the subscriber.

One of ordinary skill in the art will appreciate that the notification application 123 (and any associated or other modules described herein) may be implemented in software, hardware, firmware, or a combination thereof. In one embodiment, the systems are implemented in software or firmware that is stored in a memory and that is executed by a suitable instruction execution system, such as, for example, an instruction system operable on a computing device 102 or the server(s) 122. In software or firmware embodiments, the logic may be written in any suitable computer language. In hardware embodiments, the systems may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Referring to FIG. 1, the notification application 123 comprises the logic and/or functionality for enabling the non-participant computing device 300 to monitor conference events, exchange out-of-conference messages with participants, and/or control aspects of the conference (e.g., close or terminate an existing meeting, reschedule a meeting, etc.) without necessarily joining the conference as a participant.

As described in the above-referenced parent patent applications, the notification application 123 may support various communication channels between the conferencing system 106 and the non-participant computing device 300. A first channel may comprise a conference monitor channel that provides various features related to monitoring events associated with the conference and providing conference alerts or notifications to the non-participant computing device 300. A second channel may comprise an out-of-conference messaging channel, which enables the non-participant to send and/or receive messages from the participants 104 without necessarily joining the conference. A third channel may comprise a data channel for sending conference control signals from the non-participant computing device 300 to the conferencing system 106 (e.g., close or terminate the conference, reschedule a conference, etc.).

The notification application 123 may reside on the non-participant computing device 300 and/or the conferencing system 106. Logic associated with the non-participant computing device 300 may be implemented via native and/or web applications, plug-ins, browser 142, etc. In the embodiment illustrated in FIG. 1, the notification application 123 is illustrated as residing on the conferencing system 106, although it should be appreciated that portions of the logic or related logic may be located at, and/or controlled by, the conferencing system 106 or other computer devices, systems, etc. The notification application 123 may be configured to monitor the conference and notify the non-participant of any desirable event (e.g., that a conference has started, participant(s) 104 have joined the conference by showing the name and number of participants 104 via a push from the application, among other mechanisms). As participants 104 join, the notification may maintain a count of the number of participants 104. It may also allow the non-participant to quickly enter the conference from the application, automatically enter the conference upon the occurrence of a predetermined event, modify settings prior to an audio conference 124 starting, and provide easy access to account numbers. The notification application 123 may display a menu or other functionality that enables users to modify certain settings, configurations, options, etc.

While the notification application 123 is executing on non-participant computing device 300, it may communicate with the conferencing system 106 using, for example, a conferencing API 127. The communications may comprise, for example, status checks of the user's conferencing bridges or locations to determine if there are any active participants 104. In the event that someone has entered the user's location or joined one of their bridges via a phone, this activity may be transmitted to the application as a status update. The update may include other information about the newly joined participant 104 such as the incoming phone number, email address, name, or other identifiable details that may determined using, for example a caller ID database.

The notification application 123 alerts the non-participant by displaying a message on the display 145. In an embodiment, the message may appear for a pre-determined amount of time, which may be configurable in the application's settings. The content of the message may further include the details transmitted in the status update mentioned above. The message display may also provide a mechanism for the user to acknowledge the message by, for example, cancelling the message, joining a conference, or sending a message to participant(s) 104. If the user chooses to cancel a particular message, subsequent messages will appear as new participants 104 join a location or audio bridge, with a running tally indicating the total number of participants. If the user chooses to join their own location, the alerts will cease until the event has ended.

The notification application 123 may comprise logic for monitoring the audio conference 124 and the content/functionality presented in the conference user interface 126 to the participants 104 and providing alerts, notifications, or other messages (collectively referred to as “alerts” or “notifications”) to the non-participant. An alert may comprise audio, video, text, graphics, or other information embodied in any medium and presentable via hardware and/or software components supported by the non-participant computing device 300, including, a browser 142, an operating system 140, a GUI 148, a microphone, and a display 145, such as, for example, a touchscreen.

The notification application 123 may provide alerts based on various events monitored by the conferencing system 106. For instance, the notification application 123 may notify a host when an audio conference 124 or conference has started and alert the host to who has joined the audio conference 124 or accessed the conference by showing, for example, the participant name, the number of current participants, etc. The alerts may be implemented using a push methodology by which the alerts are “pushed” from the conferencing system 106, a pull methodology by which the alerts are “pulled” from the conferencing system 106 by the non-participant computing device 300 using, for example, the conferencing API 127, or other alert protocols, services, methodologies, etc. As participants 104 join the audio conference 124 or the associated conference, the conferencing system 106 maintains a log or counter of the number and identity of participants 104 and provides related or other information to the host. The notification application 123 may also enable the host to conveniently access the conference interface from within the application (e.g., via a menu, key shortcut, or other user interface control), as well as modify conferencing, notification or account settings prior to or during a virtual conference, close or terminal an audio conference 124, reschedule an audio conference 124, or exchange messages with the participants 104.

In an embodiment, the notification application 123 may incorporate a user interface control for enabling users to launch the application or conveniently access certain functions or features of the application (e.g., configure remote or local settings, join a virtual conference, etc.). The user interface control may be presented in various ways depending on, for example, the configuration of the operating system 140, the GUI 148, the display type and/or size, and other hardware and/or software characteristics.

To implement the notification application 123, the conferencing system 106 may support various web services for exchanging structured information with the notification application 123. The web services may be implemented using any suitable protocol. In one embodiment, the web services may be implemented via a Representation State Transfer (REST) architecture or system. In alternative embodiments, the web services may be implemented via the Simple Object Access Protocol (SOAP) using Extensible Markup Language (XML) as the messaging format. The conferencing system 106 may respond to web service calls from the notification application 123 by either returning the requested information immediately or by initiating the request and then providing the results (later) via a polling action. One of ordinary skill in the art will appreciate that any suitable methodology may be used to exchange data between the conferencing notification application 123 and the conference system 106. For example, the data may be exchanged in real-time, near real-time, using push and/or pull notifications, or any combination thereof, any of which may be customized by the user.

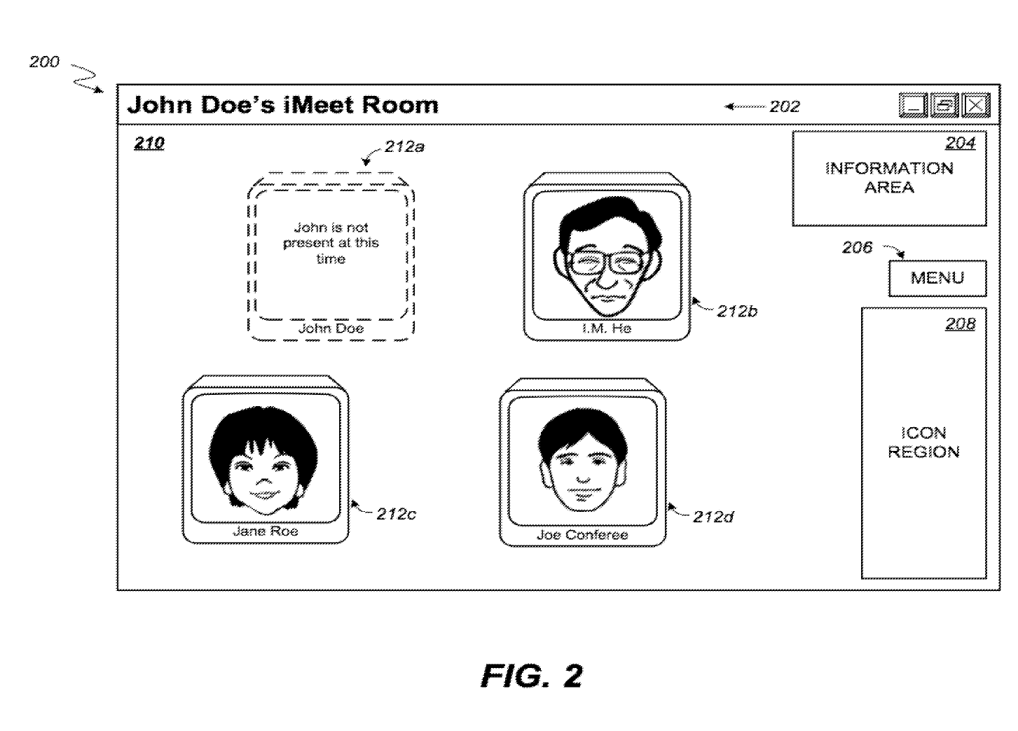

FIG. 2 is a block diagram illustrating an embodiment of an identified virtual conference published by the conferencing system 106 of FIG. 1 to the participants 104. In the illustrated embodiment, the identified virtual conference 200 is an identified interface associated with or presented by the conferencing system 106 for the benefit of subscriber John Doe. The identified virtual conference 200 comprises a computer-simulated conference location that is presented to the computing devices 102. The conference user interface 126 publishes the identified virtual conference 200 in the graphical user interface 148 associated with the display 145 of each computing device 102a-102n of subscribers who have logged in or otherwise registered their respective on-line presence in the identified virtual conference 200.

The identified virtual conference 200 or identified interface includes a title bar 202, an information area 204, a menu element 206, and an icon region 208 all superimposed on a background or panel 210. The title bar 202 includes a label identifying the interface or identified virtual conference as “John Doe's iMeet Room.” The title bar 202 further includes well recognized pushbutton controls for minimizing, maximizing and closing the interface as known in the art. The information area 204 is a portion of the panel 210 reserved for widgets or other interactive objects that information to an observer of the identified interface. For example, a weather widget may present a local outdoor temperature as well as an icon describing a local weather condition and/or the phase of the moon. By way of further example, a time/date widget may present the day of the week, day, month, year, and local time in a desired format. The menu element 206 presents one or more sub-menus when selected by John Doe or a participant authorized by John Doe to enter said menu and configure any of the items presented to the participant. The icon region 208 includes a host of icons that enable John Doe or a participant authorized by John Doe to selectively control one or more features of the identified interface 200, enter and adjust the audio conference 124, identify and share files or folders of files with select participants, or identify and register their presence in another subscriber's virtual conference location. In addition, the icon region 208 may further include individual icons to enter a help menu, search a directory of other subscribers to a conferencing service supported by the conferencing system 106 and perform similar functions. The panel 210 may include a generic background or a themed background as pre-configured by an administrator of the conferencing system 106 or as reconfigured by John Doe. The panel 210 may include additional controls for adjusting one or more aspects of identified interface 200.

In the illustrated embodiment, the panel 210 includes participant objects 212 associated with respective participants of a scheduled conference. In an alternative embodiment, a group of participants is associated with a respective object that represents the group. Each of the participant objects 212 includes a 3D rendition of a cube. The front face of each of the participant objects 212 includes an icon or a photograph representing a respective conference participant that has registered their presence in the identified interface. The respective frame of each of the participant objects 212 includes the name of the corresponding scheduled conference participant. For example, participant object 212b includes an image and the name of I.M. He, participant object 212c includes an image and the name of Jane Roe, and participant object 212d includes an image and the name of Joe Conferee. In contrast, the participant object 212a associated with John Doe does not include an image as an indication to the others that John has not registered his presence in the identified interface 200. As an additional indication that the John Doe is not present, the participant object 212a may be rendered with any one of dashed lines, in a light grayscale, in a separate color or with a message to indicate to the participants that John is not present.

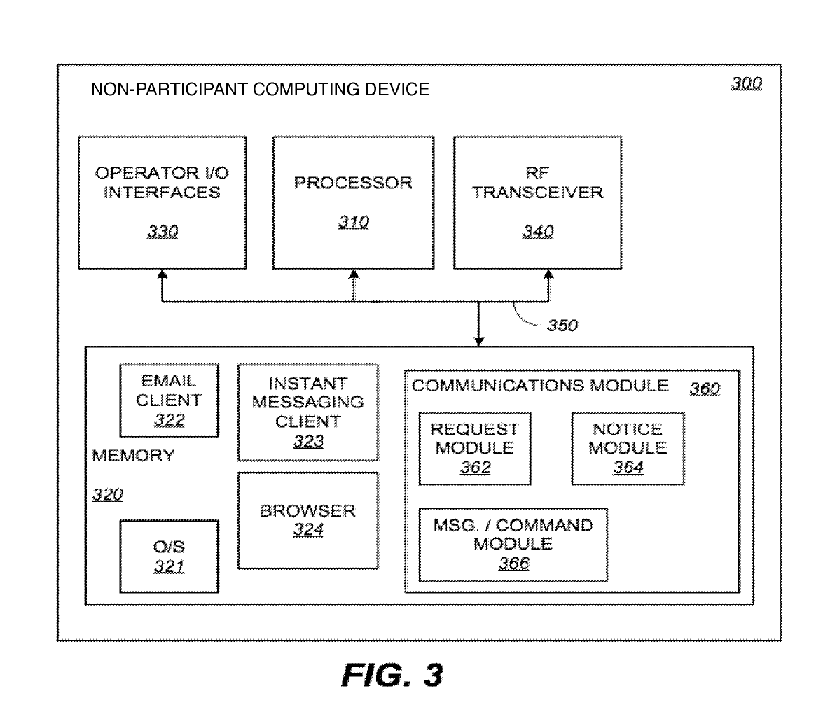

FIG. 3 is a schematic diagram illustrating an embodiment of the non-participant non-participant computing device 300 of FIG. 1. In the illustrated embodiment, the non-participant non-participant computing device 300 is a mobile device under the control and operation of a subscriber to a conferencing service supported by the conferencing system 106. The subscriber is not presently participating in the audio conference 124 and is not presently registered or present in the interface 200 (FIG. 2). In alternative embodiments, the device can be a desktop computer, a laptop computer, a tablet computer or other computing device. The non-participant non-participant computing device 300 communicates requests, messages and under certain circumstances commands to and receives notices from the conferencing system 106 (FIG. 1) via a wireless data network such as the network 110 (FIG. 1).

As illustrated in FIG. 3, the non-participant non-participant computing device 300 includes a processor 310, a memory element 320, operator input/output (I/O) interfaces 330, and a radio frequency (RF) transceiver 340, in communication with one another or coupled together by way of a local bus 350. The operator I/O interfaces 330 represent any interface with which a user, such as the subscriber or operator, may interact with the non-participant non-participant computing device 300. For example, the operator I/O interfaces 330 may include a speaker, a display, a keyboard, a microphone, a trackball, a thumbwheel, or any other user-interface element. The operator I/O interfaces 330 further include a graphical-user interface that uses various displays, menus, icons and the like to controllably configure, enable and interact with the various functions and capabilities of the non-participant non-participant computing device 300.

A power source (not shown), which may be a direct current (DC) battery or other power source, is also connected to the local bus 350 to provide power to the various elements of the non-participant non-participant computing device 300. In a particular embodiment, the non-participant non-participant computing device 300 can be, for example but not limited to, a portable telecommunication device such as a mobile cellular-type telephone.

The processor 310 and the memory element 320 provide the signal timing, processing and storage functions for the non-participant non-participant computing device 300. The processor 310, working in conjunction with parameters and executable software stored in the memory element 320, provides data and control signals to and receives data from the RF transceiver 340. The RF transceiver 340 receives data from remote transmitters and forwards the received data to the processor 310 for further processing. The RF transceiver 340 includes a transmitter, a receiver, a power amplifier, and a power amplifier controller (all not shown) that enable radio communication to and from the non-participant non-participant computing device 300. The RF transceiver 340 enables the non-participant non-participant computing device 300 to communicate with various devices, including the conferencing system 106 and computing devices 102 over one or more wireless and wired data networks 110 (FIG. 1).

Processor 310 is a hardware device for executing software, particularly software stored in the memory element 320. The processor 310 can be any custom made or commercially available processor, a CPU, an auxiliary processor among several processors associated with the non-participant non-participant computing device 300, a semiconductor based microprocessor (in the form of a microchip or chip set), or generally any device for executing software instructions.

The memory element 320 can include any one or combination of volatile memory elements (e.g., RAM, such as DRAM, SRAM, SDRAM, etc.)) and nonvolatile memory elements (e.g., a solid state drive). Moreover, the memory element 320 may incorporate electronic, magnetic, optical, and/or other types of storage media. Note that the memory element 320 can have a distributed architecture, where various components are situated remote from one another, but can be accessed by the processor 310. Components within memory 320 include storage locations for software programs and data items.

The software in the memory element 320 may include one or more separate programs, each of which comprises an ordered listing of executable instructions for implementing logical functions. In the example of FIG. 3, the software in the memory element 320 includes operating system (O/S) 321, email client 322, instant messaging client 323, browser 324 and a communications module 360. The operating system 321 essentially controls the execution of other programs, such as the email client 322, the instant messaging client 323, the browser 324 and the communications module 360 and provides scheduling, input-output control, file and data management, memory management, and communication control and related services.

The email client 322 comprises one or more programs and one or more data elements that enable the non-participant non-participant computing device 300 to manage the operator's email accounts. More specifically, the email client 322 enables the operator to compose and deliver email messages from the one or more email accounts as well as receive and review email messages that are sent to the operator's one or more email accounts.

The instant messaging client 323 comprises one or more programs and one or more data elements that enable the non-participant non-participant computing device 300 to manage the operator's instant messages. More specifically, the email client 322 enables the operator to compose, deliver, receive and review instant messages using one or more instant messaging protocols for the transfer of messages. Some known instant messaging clients also include voice over Internet protocol and video conferencing capabilities.

The browser 324 comprises one or more programs and one or more data elements that enable the non-participant non-participant computing device 300 to retrieve, present and traverse information available on the world wide web. Information resources are identified by a uniform resource locator and may be a page, image, video, or some other content. Thus, the browser 324 can be operated to enable the communication of a message to one or more of the participants present in the interface 200 via a social networking channel or application. Each information resource may include links that when selected by the non-participant non-participant computing device 300, enable the operator to access, retrieve and review other related resources over a private data network or the public access data network known as the Internet.

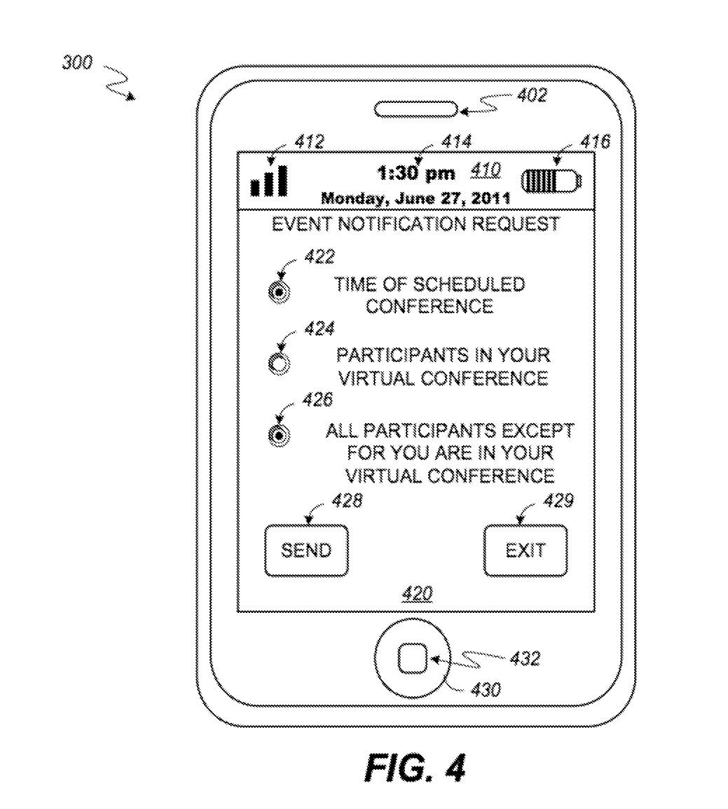

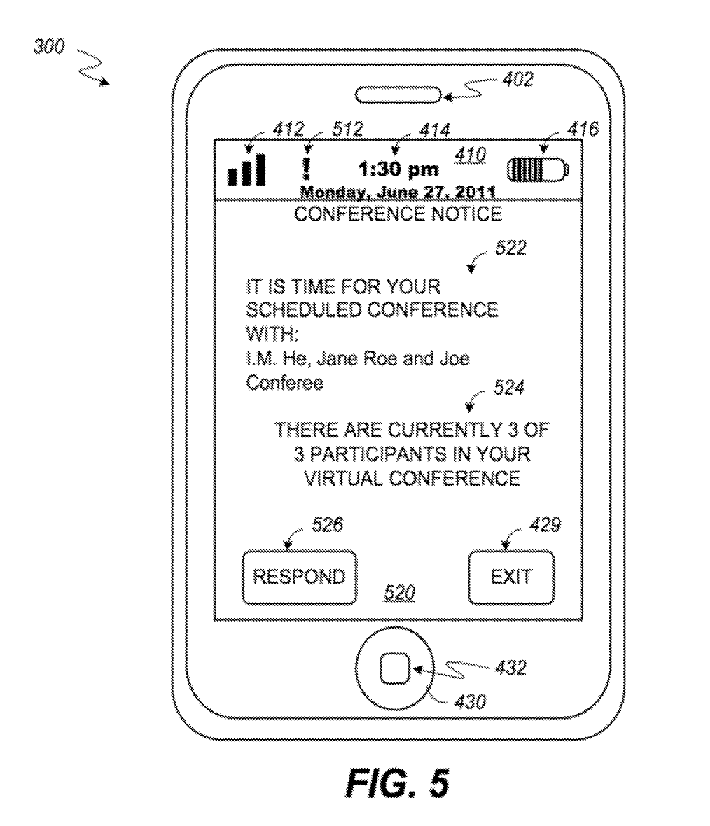

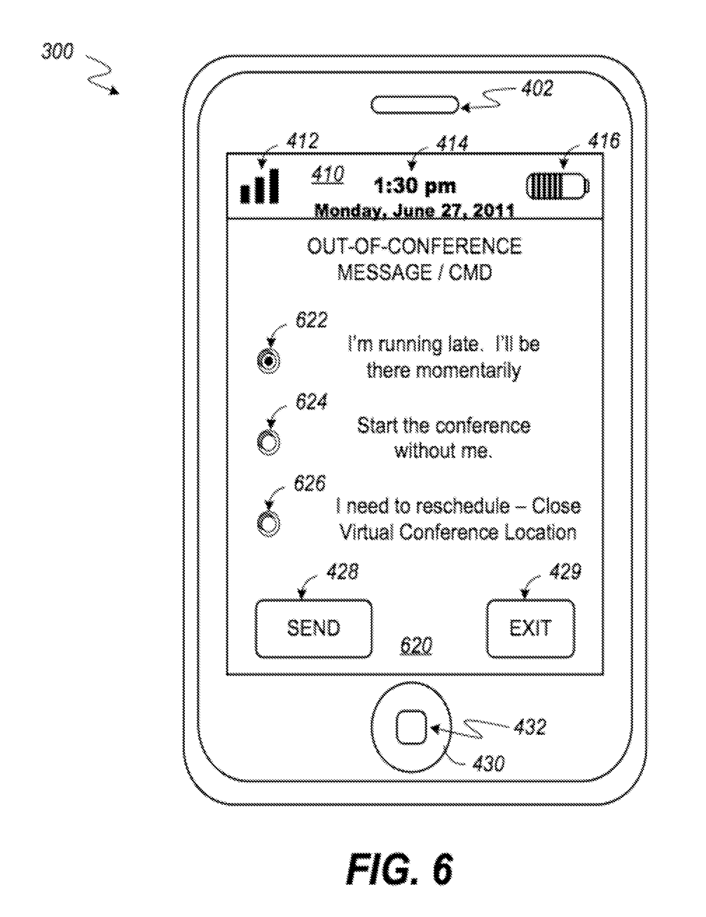

The communications module 360 includes a request module 362, a notice module 364, and a message/command module 366. The request module 362 includes one or more programs (i.e., executable logic or executable instructions) and one or more data elements that enable the non-participant non-participant computing device 300 to present and operate an event notification request interface. An exemplary embodiment of such an event and notification request interface is illustrated in FIG. 4 and described in the related portions of this document. Similarly, the notice module 364 includes one or more programs (i.e., executable logic or executable instructions) and one or more data elements that enable the non-participant non-participant computing device 300 to present and operate a conference notice interface. An exemplary embodiment of such a conference notice interface is illustrated in FIG. 5 and described in the related portions of this document. Lastly, the message/command module 366 includes one or more programs (i.e., executable logic or executable instructions) and one or more data elements that enable the non-participant non-participant computing device 300 to present and operate an out-of-conference message/command interface. An exemplary embodiment of such an out-of-conference message/command interface is illustrated in FIG. 6 and described in the related portions of this document.

When the non-participant non-participant computing device 300 is in operation, the processor 310 is configured to execute software stored within the memory 320, to communicate data to and from the memory 320, and to generally control operations of the non-participant non-participant computing device 300 pursuant to the software. The email client 322, the instant messaging client 323, the browser 324, the communications module 360 and the O/S 321, in whole or in part, but typically the latter, are read by the processor 310, perhaps buffered within the processor 310 and then executed.

When the email client 322, the instant messaging client 323, the browser 324, the communications module 360 and the O/S 321 are implemented in software, as is shown in FIG. 3, it should be noted that the email client 322, the instant messaging client 323, the browser 324, the communications module 360 and the O/S 321 can be stored on any computer-readable medium for use by or in connection with any computer related system or method. In an alternative embodiment, where the email client 322, the instant messaging client 323, the browser 324, and the communications module 360 are implemented in hardware, the email client 322, the instant messaging client 323, the browser 324, and the communications module 360 can be implemented with any or a combination of the following technologies, which are each well known in the art: a discrete logic circuit(s) having logic gates for implementing logic functions upon data signals, an ASIC having appropriate combinational logic gates, a PGA, a FPGA, etc.

FIG. 4 is a schematic diagram illustrating an embodiment of a machine interface embodied on a mobile device for communicating a request to the conferencing system 106 of FIG. 1. An example non-participant non-participant computing device 300 includes a graphical display with an information panel 410 and a notification request interface 420. The non-participant non-participant computing device 300 further includes a transducer or speaker 402, a two-axis control 430 and a selection pad 432.

The information panel 410 includes a signal strength indicator 412, a time/date element 414 and a battery capacity indicator 416. The notification request interface 420 includes a send element 428 and an exit element 429 as well as select indicator 422, select indicator 424 and select indicator 426. The select indicator 422 indicates that the operator of the non-participant computing device 300 is interested in being notified when it is time for a scheduled conference. That is, when it is time to join the audio conference 124 and to register one's presence in the interface 200. The select indicator 424 indicates that the operator of the non-participant computing device 300 is interested in being notified when one or more participants have entered the virtual conference. That is, when one or more subscribers to the conferencing system 106 have entered the interface 200. The select indicator 426 indicates that the operator of the non-participant computing device 300 is interested in being notified when all other scheduled conference participants are present in the interface 200. Each of the select indicator 422, select indicator 424, select indicator 426, send element 428, and the exit element 429 are selected by manipulating a cursor 421 about the notification request interface by pressing the two-axis control 430 and pressing the selection pad 432 when the cursor is in registration with the desired select indicator or element.

Alternative embodiments of an event notification request interface may include one or more other controls including but not limited to voice activated controls, touch screens, or other positioning devices to communicate a request for notice of event associated with or that has occurred in the interface 200. In addition, the number and subject matter of illustrated requests are presented by way of example only. Alternative embodiments of an event notification interface may include additional controls as may be required to scroll through an extended list of optional events that are desired to initiate a notice to the requesting non-participant computing device 300. In addition, one or more alternative embodiments may include the capability to communicate a unique or personalized request to receive an indication of an event that may occur in the interface 200 (FIG. 2).

FIG. 5 is a schematic diagram illustrating an embodiment of a machine interface embodied on a mobile device for receiving a notice from the conferencing system 106 of FIG. 1. An example non-participant non-participant computing device 300 includes a conference notice interface 520 with the information panel 410, transducer or speaker 402, two-axis control 430 and the selection pad 432 as described in association with the embodiment illustrated in FIG. 4. As illustrated in FIG. 5, the conference notice interface 520 includes a first notice 522, a second notice 524, and a respond element 526.

The first notice 522 is in response to operator selection of the select indicator 422 (FIG. 4) and the passage of time to a start time associated with a scheduled conference with the indicated participants. The second notice 524 is in response to operator selection of the select indicator 426 (FIG. 4) and each of the scheduled participants registering their presence in the interface 200 (FIG. 2). The respond element 526 indicates that the operator of the non-participant computing device 300 is interested in communicating in some way with one or more participants present in the interface 200, without joining the interface 200 at the present time. That is, the operator desires to initiate and send an out-of-conference communication. The respond element 526 is selected by manipulating a cursor 421 about the conference notice interface 520 by pressing the two-axis control 430 to position the cursor 421 over the respond element 526 and pressing the selection pad 432.

In addition to the signal strength indicator 412, time/date element 414 and battery capacity indicator 416 introduced in association with the description of FIG. 4, the information panel 410 includes a notice element 512. In the illustrated embodiment, the notice element 512 is in the form of an exclamation point. In alternative embodiments (not shown) the notice element 512 may include other symbols and may be presented with one or more characteristics or features that are likely to capture the attention of an operator. For example, the notice element 512 may be emboldened, presented in a color that is different from other items in the information panel 510, turned on and turned off at desired intervals, varied in size and/or position over time or presented using other techniques.

Alternative embodiments of a conference notice interface may include one or more other controls including but not limited to voice activated controls, touch screens, or other positioning devices to communicate the desire to send a message via any number of application interfaces and communication protocols and/or a command to the conferencing system 106. The number and subject matter of notices in the illustrated embodiment are presented by way of example only. Alternative embodiments of a conference notice interface may include additional controls as may be required to scroll through an extended list of notices presented on the requesting non-participant computing device 300.

FIG. 6 is a schematic diagram illustrating an embodiment of a machine interface embodied on a mobile device 300 for communicating an out-of-conference message to participants present in the identified virtual conference or interface 200 of FIG. 2 and/or a command to the conferencing system 106. An example non-participant non-participant computing device 300 includes an out-of-conference message/command interface 620 with the information panel 410, transducer or speaker 402, two-axis control 430 and the selection pad 432 as described in association with the embodiment illustrated in FIG. 4. As illustrated in FIG. 6, the out-of-conference message/command interface 620 includes a first selection indicator 622, a second selection indicator 624, and a third selection indicator 626.

The first selection indicator 622 is associated with a message indicating that the operator of the non-participant computing device 300 is running late and will join the virtual conference interface 200 and the audio conference 124 momentarily. The second selection indicator 624 is associated with a message to start the conference without the operator of the non-participant computing device 300. The third selection indicator 626 is associated with a message and a command. The message indicates that the operator of the non-participant computing device 300 will reschedule the meeting. The command directs the conference system 106 to close the virtual conference interface 200 (FIG. 2).

Each of the first selection indicator 622, second selection indicator 624, third selection indicator 626, send element 428, and the exit element 429 are selected by pressing the two-axis control 430 to position the cursor 421 over the desired control element and pressing the selection pad 432.

Alternative embodiments of an out-of-conference message/command interface may include one or more other controls including but not limited to voice activated controls, touch screens, or other positioning devices to communicate the desire to send a message via any number of application interfaces and communication protocols and/or a command to the conferencing system 106. In addition, the number and subject matter of illustrated messages and/or the example command are presented for illustration and are not limiting. Alternative embodiments of an out-of-conference message/command interface may include additional controls as may be required to scroll through an extended list of messages and/or commands presented on the requesting non-participant computing device 300. In addition, one or more alternative embodiments may include the capability to communicate a unique or personalized message.

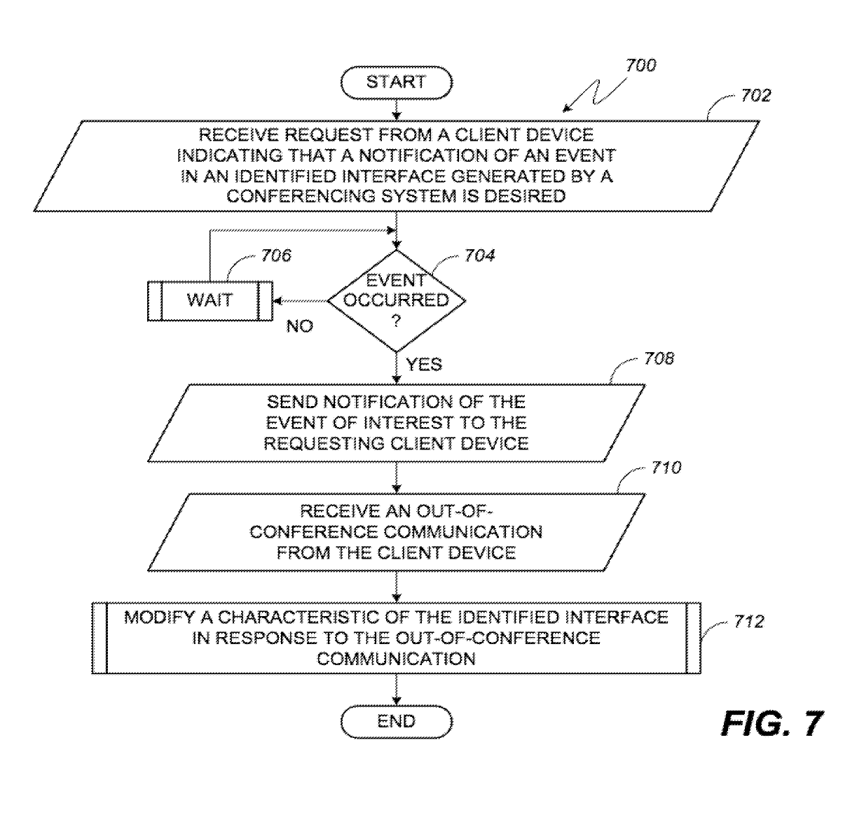

FIG. 7 is a flow diagram illustrating an embodiment of a method for monitoring a conference interface and communicating with participants without joining as a participant. In input/output block 702, a conferencing system 106 receives a request from a non-participant computing device 300 indicating that a notification of an event in an identified interface generated by the conferencing system 106 is desired. For example, an event that may be of interest to a subscriber that is not present in the identified interface is when a subscriber to a conferencing service provided by the conferencing system 106 has entered the identified interface. A non-participant might also be interested when an identified subscriber such as a supervisor has entered the identified interface. By way of further example, a non-participant may be interested when a desired number of expected or scheduled participants of a conference are present in the identified interface.

As indicated in decision block 704, the conferencing system 106 determines when an event of interest has occurred in the identified interface. When the event has not occurred, the conferencing system 106 is configured to return to decision block 704 after waiting a desired time as illustrated in block 706. The duration of the wait or delay introduced in block 706 may be predetermined and non-configurable. Alternatively, the duration or wait of the delay introduced in block 706 may be configurable by an operator of the conferencing system 106.

Otherwise, when the event of interest has occurred, as indicated by the flow control arrow labeled “Yes” exiting decision block 704, the conferencing system 106 proceeds to block 708 where a notice of the occurrence of the event of interest is communicated to the requesting non-participant computing device 300. The notice communicated to the requesting non-participant computing device 300 can be graphical only, text-based only, or a combination of graphics and text that can be presented on the non-participant computing device 300. The notice may include an indication that it is time for a scheduled conference. Alternatively, the notice may include the number and/or the identity of participants that have entered the identified interface. This alternative embodiment may be further configured to notify the non-participant when all scheduled participants to a conference have entered the identified interface.

In some embodiments, receipt of the notice is augmented with a tone, vibration or both to alert the operator of the non-participant computing device 300 that an event of interest has occurred. In an example embodiment, the notice or notification communicated to the non-participant computing device 300 includes a prompt for the operator of the non-participant computing device 300 to select whether to join the conference or compose an out-of-conference message for presentation in the identified interface. Example out-of-conference messages could include one or more of “I'll be there momentarily,” “I'll be N minutes late,” or “I'll need to reschedule at a later time,” among others. These out-of-conference messages may be pre-configured. In addition to pre-configured messages, the conferencing system 106 may present an option for the operator of the non-participant computing device 300 to enter a message different from the pre-configured messages.

In input/output block 710, the conferencing system receives an out-of-conference communication from the non-participant non-participant computing device 300. The out-of-conference communication may include a message or command to modify a characteristic of the identified interface. For example, the out-of-conference communication may include a command that limits the number of subscribers that can register their presence (i.e., enter) the identified interface. By way of further example, the out-of-conference communication may include a command that closes the identified interface. The command to close the interface may be accompanied by a message or warning to those present in the interface that the interface is about to close. Thereafter, as indicated in block 712, the conferencing system 106 modifies a characteristic of the identified interface in response to the out-of-conference communication received from the non-participant non-participant computing device 300.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in a volatile memory or non-volatile memory and that is executed by hardware (e.g., microcontroller) or any other processor(s) or suitable instruction execution system associated with the conference system. Furthermore, the logical functions may be embodied in any computer readable medium for use by or in connection with an instruction execution system, apparatus, or device, such as a computer-based system, processor-containing system, or other system associated with the conference system that can fetch the instructions from the instruction execution system, apparatus, or device and execute the instructions.

It should be noted that this disclosure has been presented with reference to one or more exemplary or described embodiments for the purpose of demonstrating the principles and concepts of the systems and methods for monitoring and interacting with a conferencing platform without joining or registering presence within a conference interface. The systems and methods are not limited to these embodiments. As will be understood by persons skilled in the art, in view of the description provided herein, many variations may be made to the embodiments described herein and all such variations are within the scope of the appended claims.

What is claimed is:

1. A method for monitoring and controlling a conference interface without joining as a participant to the conference, the method comprising:
receiving at a conferencing system, a request communicated from a computing device, the request including an indication that a notification of an event associated with an identified interface generated by the conferencing system is desired;
the conferencing system, determining the occurrence of the event;
the conferencing system, sending a notification to the computing device, the notification indicating the occurrence of the predetermined event;
receiving at the conferencing system, an out-of conference communication from the computing device; and
the conferencing system, in response to the out-of-conference communication modifying a characteristic of the identified interface.

2. The method of claim 1, wherein receiving the request for notification of an event comprises a subscriber to the conferencing service provided by the conferencing system entering the identified interface.

3. The method of claim 2, wherein the identified interface is associated with an identified subscriber that is not presently registered in the identified interface.

4. The method of claim 2, wherein the identified interface is associated with an audio conference.

5. The method of claim 4, wherein the identified subscriber has not joined the audio conference.

6. The method of claim 1, wherein sending the notification to the computing device comprises an indication of those subscribers that have registered their presence in the identified interface.

7. The method of claim 1, wherein sending the notification to the computing device comprises a prompt to direct the conferencing system to take one or more of the following actions: join the identified interface; and compose an out-of-conference message for presentation in the identified interface.

8. The method of claim 1, wherein modifying a characteristic of the identified interface comprises closing the identified interface.

9. The method of claim 1, wherein modifying a characteristic of the identified interface comprises limiting the number of subscribers that can register their presence in the identified interface.

10. A computer program embodied in a computer readable medium and executed by a processor for monitoring an interface and communicating with a conferencing system managing the interface, the computer program comprising:
logic for communicating a request to the conferencing system from a computing device, the request including an indication that a notification of an event associated with an identified interface generated by the conferencing system is desired, the identified interface comprising a graphical user interface published by the conferencing system and associated with an operator of the computing device;
logic for receiving a notification from the conferencing system at the computing device, the notification indicating the occurrence of the predetermined event; and
logic for communicating with the conferencing system from the computing device outside of the graphical user interface published by the conferencing system, a communication from the computing device that directs the conferencing system to modify a characteristic of the graphical user interface published by the conferencing system.

11. The computer program of claim 10, wherein the logic for communicating a request for notification of an event associated with the identified interface comprises logic that enables a subscriber to the conferencing service provided by the conferencing system to request notification of a conference participant registering their presence in the identified interface.

12. The computer program of claim 10, further comprising:
logic configured to expose the identity of at least one subscriber that has registered their presence in the identified interface.

13. The computer program of claim 12, further comprising:
logic configured to communicate a message to the at least one subscriber via one of a social networking channel, an instant message, and an email message.

14. The computer program of claim 12, further comprising:
logic configured to communicate a message to the at least one subscriber via the graphical user interface published by the conferencing system.

15. The computer program of claim 10, wherein logic for communicating with the conferencing system from the computing device outside of the graphical user interface published by the conferencing system, a communication that directs the conferencing system to modify a characteristic of the graphical user interface published by the conferencing system comprises closing the identified interface.

16. The computer program of claim 10, wherein logic for communicating with the conferencing system from the computing device outside of the graphical user interface published by the conferencing system, a communication that directs the conferencing system to modify a characteristic of the graphical user interface published by the conferencing system comprises limiting the number of subscribers that can register their presence in the identified interface.

17. A conferencing system that enables a subscriber thereof to monitor and respond to activity in an interface published by the conferencing system, the conferencing system comprising:
a conference platform operating a web server that publishes a graphical user interface associated with an identified subscriber;
computing devices associated with respective subscribers to a service enabled by the conferencing platform, the computing devices coupled to the conference platform via one or more networks, wherein one of the computing devices is associated with a subscriber that has not registered their presence in the graphical user interface published by the conferencing system, the computing device comprising:
a processor and a memory in communication with the processor; and
an application embodied in the memory and executed by the processor, the application including:
logic for communicating a request to the conferencing platform from the computing device, the request including an indication that a notification of an event associated with the graphical user interface is desired;
logic for receiving a notification from the conferencing platform at the computing device, the notification indicating occurrence of the predetermined event; and
logic for communicating with the conferencing platform from the computing device outside of the graphical user interface, a communication that directs the conferencing system to modify a characteristic of the graphical user interface.

18. The conferencing system of claim 17, further comprising:
logic configured to expose the identity of at least one subscriber that has registered their presence in the graphical user interface.

19. The conferencing system of claim 18, further comprising:
logic configured to communicate a message to the at least one subscriber that has registered their presence in the graphical user interface via one of a social networking channel, an instant message, and an email message.

20. The conferencing system of claim 18, further comprising:
logic configured to communicate a message to the at least one subscriber that has registered their presence in the graphical user interface via the graphical user interface published by the conferencing platform.
